(19) United States
(12) Patent Application Publication
(10) Pub. No.: US 2008/0088253 A1
(43) Pub. Date: Apr. 17, 2008

(54) Method for Operating a High-Pressure Discharge Lamp, Operating Appliance for a High-Pressure Discharge Lamp, and Illumination Device

(75) Inventor: Michael Bonigk, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/883,516

(22) PCT Filed: Jan. 31, 2006
(86) PCT No.: PCT/DE06/00137

§ 371 Date: Aug. 1, 2007

(30) Foreign Application Priority Data
Feb. 2, 2005 (DE) 102005004916.8

(51) Int. Cl. H05B 41/292; H05B 37/00

(52) U.S. Cl. 315/225; 315/82

(57) ABSTRACT

A method for operating a high-pressure discharge lamp having an electrical voltage with a periodically alternating polarity. According to said method, during the operation of the high-pressure discharge lamp, the lamp is monitored for flickering, the occurrence of vibration, and preferably the exceeding of static parameters (e.g. lamp overvoltage) of the high-pressure discharge lamp.

The invention relates to a method for operating a high-pressure discharge lamp in accordance with the preamble of patent claim 1 and control gear having a device for carrying out the method and an illumination device having a high-pressure discharge lamp and control gear.

### I. PRIOR ART

Such a method and control gear for carrying out such a method are disclosed, for example, in the patent specification U.S. Pat. No. 5,973,457. This specification describes control gear for a high-pressure discharge lamp having a device for detecting a flickering state of the high-pressure discharge lamp. That is to say, flickering of the discharge arc of the high-pressure discharge lamp is detected and, in the event of the repeated occurrence of a flickering state, the high-pressure discharge lamp is switched off if the light-off time lasts for longer than a predetermined first duration and the light-on time is shorter than or equal to a predetermined second duration.

One disadvantage with this method and this control gear consists in the fact that only severe flickering of the discharge arc which causes the discharge arc to be extinguished temporarily can be detected in this way. It is not possible with the aid of this method and this control gear to detect the preliminary stages of the severe flickering, for example flicker of the discharge arc which does not cause it to be extinguished temporarily but is only demonstrated in comparatively slight fluctuations in the running voltage of the high-pressure discharge lamp or the lamp current. A further disadvantage of the method and the control gear in accordance with the abovementioned patent specification consists in the fact that, with this method and control gear, it is not possible to distinguish between flickering of the discharge arc owing to the end of life of the lamp having been reached and fluctuations in the discharge arc owing to shaking or vibrations of the high-pressure discharge lamp. As a result, such fluctuations are erroneously detected as a defect in the lamp by the control gear in accordance with the abovementioned prior art.

### II. DESCRIPTION OF THE INVENTION

The object of the invention is to specify an improved method for operating a high-pressure discharge lamp which distinguishes between different causes for the fluctuations of the discharge arc of the high-pressure discharge lamp.

This object is achieved according to the invention by the features of patent claim 1. Particularly advantageous embodiments of the invention are described in the dependent patent claims.

The method according to the invention for operating a high-pressure discharge lamp with an electrical voltage with a periodically alternating polarity includes monitoring of the occurrence of flickering or flicker states in the high-pressure discharge lamp and, in addition, monitoring of the occurrence of shaking or vibrations in the high-pressure discharge lamp. This ensures that fluctuations of the discharge arc of the high-pressure discharge lamp owing to shaking or vibrations of the high-pressure discharge lamp are not confused with flickering or flicker states of the high-pressure discharge lamp and assessed as being a defect in the lamp. In particular in the case of high-pressure discharge lamps which are used as a light source in motor vehicles, for example in vehicle headlamps, this ensures that fluctuations of the discharge arc owing to shaking or vibrations, for example as a result of poor road conditions, do not trigger the end-of-life shutdown of the high-pressure discharge lamp by its control gear.

Advantageously, monitoring for shaking or vibrations is only carried out during the occurrence of flickering and flicker states of the high-pressure discharge lamp in order to configure the method to be as effective as possible and because only in the event of the occurrence of flickering or flicker states is it necessary to decide whether the fluctuations of the discharge arc are brought about by shaking or vibrations of the high-pressure discharge lamp and will disappear again once the shaking or vibrations have died down.

In order to monitor the occurrence of flickering or flicker states and of shaking or vibrations of the high-pressure discharge lamp, an electrical lamp operation parameter or an electrical variable correlated therewith or derived therefrom is advantageously monitored. This lamp operation parameter is preferably either the running voltage of the high-pressure discharge lamp or the lamp current, since both lamp operation parameters are in any case measured and evaluated by the control gear during lamp operation for power control in the high-pressure discharge lamp and fluctuations of the discharge arc of the high-pressure discharge lamp, for example owing to flickering or flicker states or owing to shaking or vibrations, are reflected in both lamp operation parameters. The running voltage is the operating voltage of the high-pressure discharge lamp or the voltage across the high-pressure discharge lamp once its ignition and runup phase has ended in virtually steady-state operation.

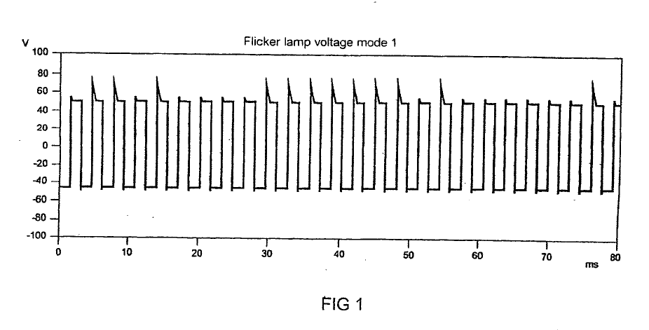

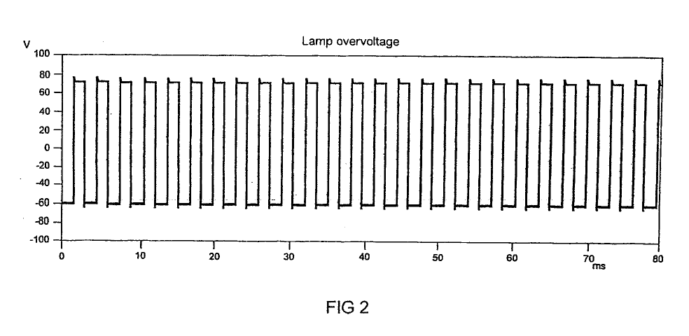

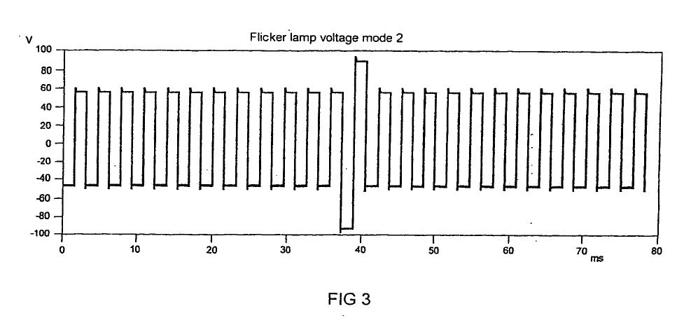

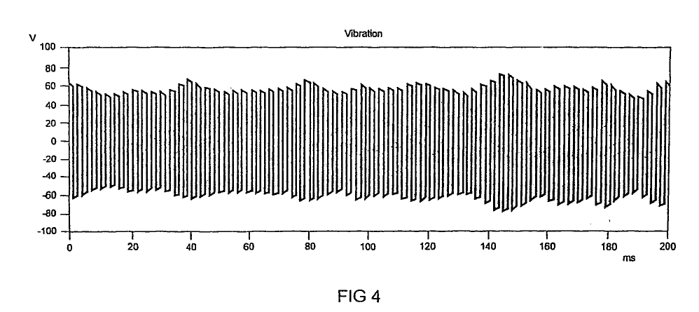

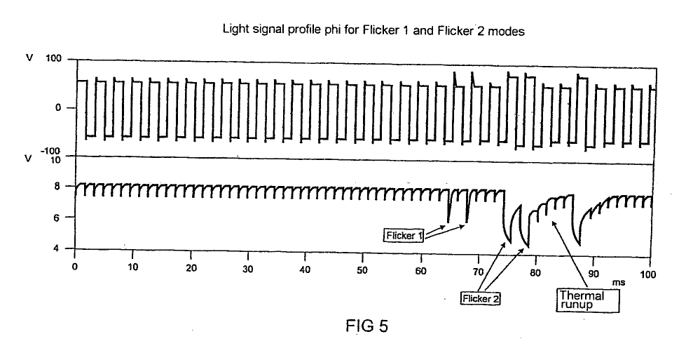

Experiments have shown that, in the case of high-pressure discharge lamps which are operated with an electrical voltage or an electrical current with a periodically alternating polarity, fluctuations of the discharge arc of the high-pressure discharge lamp which are based on different causes become noticeable through different changes in the abovementioned lamp operation parameters. It is therefore possible, by monitoring a lamp operation parameter, for example the running voltage of the high-pressure discharge lamp or the lamp current, to distinguish between the different causes for the fluctuations of the discharge arc. FIGS. 1, 3 and 4 show, schematically, three different running voltage profiles for different types of fluctuations of the discharge arc. In the case of fault-free lamp operation with a silent discharge arc, the running voltage profile over time would be substantially square wave. The voltage peaks, which are present in FIG. 1 (flicker lamp voltage mode 1) on the first half of a few half-cycles of the running voltage, are caused by a flicker of the discharge arc. FIG. 2 represents the running voltage profile for a high-pressure discharge lamp at an elevated running voltage. FIG. 3 (flicker lamp voltage mode 2) shows the running voltage profile for a further flicker state of the high-pressure discharge lamp. The flicker in this case influences the level of the running voltage in two half-cycles. In particular, the running voltage also has an elevated value in the second half of the half-cycles. In FIG. 4, the running voltage of the high-pressure discharge lamp has a modulated profile, which is caused by shaking or vibrations of the lamp. FIG. 5 represents, in the upper curve, the time profile of the running voltage for the two abovementioned flicker states and, in the lower curve, the associated time profile of the luminous flux which is emitted by the discharge arc.

Advantageously, in accordance with the method according to the invention for monitoring the lamp operation, therefore at least one measured value of the lamp operation parameter is determined during a first time periods and at least one measured value of the lamp operation parameter is determined during a second time period, the first time period being arranged within the first half, and the second measured value being arranged within the second half, of the time interval of a half-cycle of the periodic voltage. By determining and evaluating the measured values from the first and second time periods of a half-cycle and by evaluating the measured values from the second time periods of different half-cycles of the periodic voltage, the causes of the fluctuations can be distinguished.

In order to detect the flickering or flicker state, advantageously a first comparison variable is formed from the at least one measured value during the first time period and the at least one measured value from the second time period, which first comparison variable is compared with a predetermined first reference value for the first comparison variable. As a result, flicker states of the high-pressure discharge lamp can be detected as shown in FIG. 1. In addition, advantageously a second comparison variable is formed from the at least one measured value from the second time period, which second comparison variable is compared with a predetermined second reference value for the second comparison variable. As a result, flicker states of the high-pressure discharge lamp as shown in FIG. 3 can be proven. In order to prove the influence of shaking or vibrations as shown in FIG. 4 on the lamp, advantageously the maximum value and the minimum value are determined from the measured values which were determined during the second time periods over a plurality of half-cycles, and a third comparison variable is formed therefrom which is compared with a predetermined third reference value for the third comparison variable. As a result, the influence of shaking or vibrations on the lamp operation parameter can be detected. In particular, a modulation of the lamp running voltage as shown in FIG. 4 can be detected. In order to detect the event of a maximum permissible value for the lamp operation parameter being exceeded, the measured values from the second time periods of the half-cycles of the periodic voltage are advantageously compared additionally with a predetermined fourth reference value.

The predetermined reference values are advantageously predetermined such that the second reference value is greater than the sum of the third reference value and the fourth reference value. This ensures that the combination of a high lamp running voltage with the occurrence of shaking or vibrations below the fourth or third reference value is not erroneously evaluated as indicating the presence of a flicker state. In order to establish the predetermined reference values or threshold values, in the case of a high-pressure discharge lamp during fault-free lamp operation, measured values were determined in the above-described way and first to fourth comparison variables formed therefrom in the above-described way. The corresponding predetermined reference or threshold value was formed from the respective comparison variable by addition of a predeterminable tolerance. It has proven to be particularly effective to determine in each case only one measured value during each first and second time period. It has been shown that one measured value per time period is entirely sufficient for identifying the abovementioned operating states. In addition, complex algorithms for mean-value generation which burden the evaluation unit can therefore also be dispensed with. Preferably, the measured value from the first time period is determined immediately after the change in polarity, and the measured value from the second time period is determined immediately before the change in polarity, in the corresponding half-cycle of the periodic voltage.

The control gear according to the invention for a high-pressure discharge lamp is equipped with a voltage supply circuit for applying an electrical voltage with alternating polarity to the high-pressure discharge lamp and with a device for carrying out the above-explained method. The abovementioned device preferably has a measuring apparatus for iteratively measuring a lamp operation parameter, which is influenced by a flickering or flicker state of the high-pressure discharge lamp and by shaking or vibrations, as well as an evaluation unit, which is used for evaluating the measured values determined by the measuring apparatus. The evaluation unit preferably comprises a programmable microcontroller or a logic circuit or a combination of the two in order to allow for digital or analog or analog/digital evaluation of the measured data.

The control gear according to the invention and the high-pressure discharge lamp connected to the control gear are part of an illumination system, preferably a vehicle headlamp. The high-pressure discharge lamp acts as the light source of the vehicle headlamp. The method according to the invention makes it possible to distinguish between fluctuations of the discharge arc of the high-pressure discharge lamp owing to shaking or vibrations of flickering or flicker states of the high-pressure discharge lamp.

### III. DESCRIPTION OF THE PREFERRED EXEMPLARY EMBODIMENT

The invention will be explained in more detail below with reference to a preferred exemplary embodiment. In the drawing:

FIG. 1 shows a schematic illustration of the time profile of the running voltage of a high-pressure discharge lamp during a first flicker state,

FIG. 2 shows a schematic illustration of the time profile of the running voltage of a high-pressure discharge lamp which demonstrates an elevated voltage,

FIG. 3 shows a schematic illustration of the time profile of the running voltage of a high-pressure discharge lamp during a second flicker state,

FIG. 4 shows a schematic illustration of the time profile of the running voltage of a high-pressure discharge lamp which is subjected to shaking or vibrations,

FIG. 5 shows a comparison of the time profile of the lamp running voltage (flicker modes 1 and 2) and the luminous flux of the high-pressure discharge lamp,

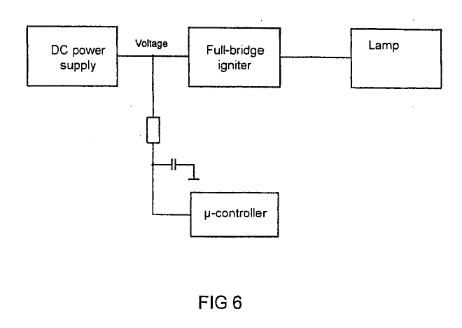

FIG. 6 shows a block circuit diagram in accordance with the first exemplary embodiment of control gear for a high-pressure discharge lamp for carrying out the method according to the invention,

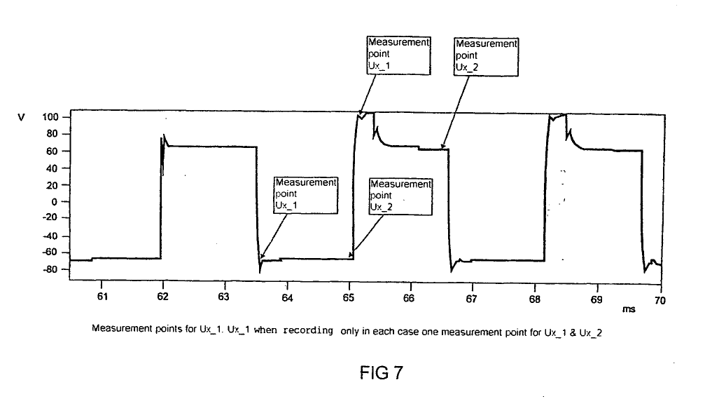

FIG. 7 shows the time profile of the lamp running voltage over a plurality of periods with assignment of the measurement times for the method according to the invention,

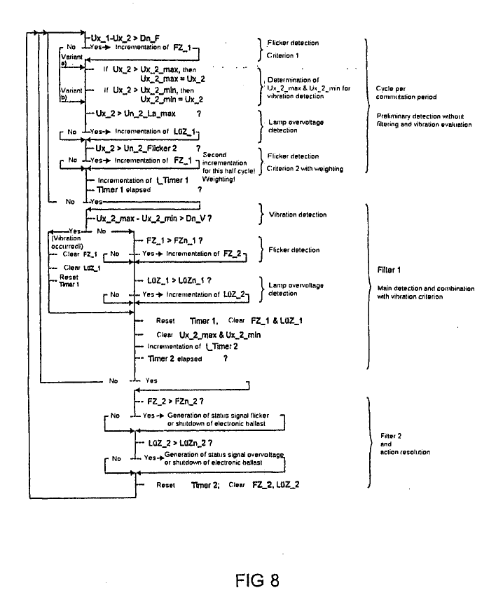

FIG. 8 shows a flowchart of the evaluation algorithm in accordance with the preferred exemplary embodiment of the method according to the invention,

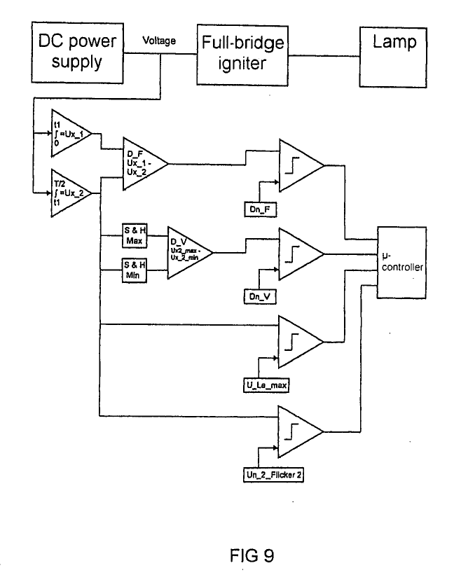

FIG. 9 shows a block circuit diagram in accordance with the second exemplary embodiment of control gear for a high-pressure discharge lamp for carrying out the method according to the invention, and

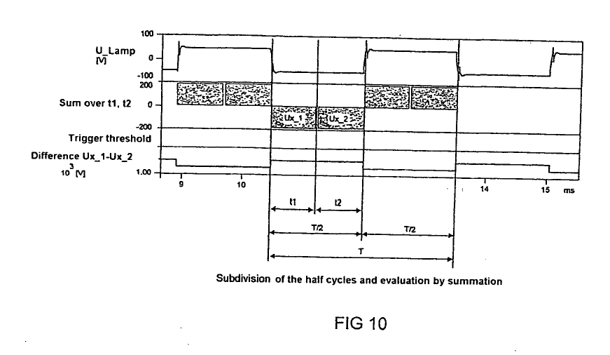

FIG. 10 shows a schematic illustration of the subdivision of the half-cycles of the lamp running voltage and the evaluation of the running voltage profile over time.

FIG. 6 shows a block circuit diagram of control gear for a high-pressure discharge lamp in accordance with the first exemplary embodiment, with the aid of which the operating method according to the invention for the high-pressure discharge lamp will be described below. The high-pressure discharge lamp is a metal-halide high-pressure gas discharge lamp having an electrical power consumption of approximately 35 watts, which is used as the light source in a motor vehicle headlamp.

The control gear is fed by the on-board system voltage of the motor vehicle. It substantially comprises a full-bridge inverter, in whose bridge branch the high-pressure discharge lamp is connected, and a DC voltage supply circuit for the full-bridge inverter and an ignition apparatus (igniter) for igniting the gas discharge in the high-pressure discharge lamp as well as a microcontroller for controlling the full-bridge inverter and its DC voltage supply circuit. Details of the circuit arrangement of such control gear are disclosed, for example, in the book “Betriebsgeräte und Schaltungen für elektrische Lampen” [Control gear and circuits for electric lamps] by C. H. Sturm and E. Klein, Siemens Aktiengesellschaft, 6th Edition from 1992, on pages 217 to 218.

The high-pressure discharge lamp is operated by means of the full-bridge inverter at a substantially square-wave AC voltage at a frequency of approximately 360 hertz. The lamp current and the running voltage of the high-pressure discharge lamp for power control of the lamp are measured and evaluated with the aid of the microcontroller and by means of measuring apparatuses. In addition, two measured values of the lamp running voltage are determined and evaluated by means of the microcontroller and a measuring apparatus, in the form of an RC element, per half-cycle of the substantially square-wave lamp running voltage, in order to detect the occurrence of flickering or flicker states in the high-pressure discharge lamp. The corresponding input of the microcontroller (μ-controller) is connected in parallel with the capacitor C of the RC element in FIG. 6. The time constant of the RC element or low-pass filter is very low in comparison with half the period duration of the lamp running voltage.

FIG. 7 illustrates schematically the time profile of the lamp running voltage over a plurality of periods. During each half-cycle of the lamp running voltage, a first measured value Ux_1, which is within the first half of the half-cycle, and a second measured value Ux_2, which is within the second half of the half-cycle, are measured. The first measured value Ux_1 from each half-cycle is determined directly after the change in polarity of the lamp running voltage, and the second measured value Ux_2 is determined directly before the next change in polarity of the lamp running voltage. Owing to voltage peaks directly after each change in polarity of the lamp running voltage, the measured values Ux_1 have a higher absolute value than the measured values Ux_2 of the same half-cycle. The measured values Ux_2 substantially correspond to the level of the plateau of the square-wave half-cycle. These measured values Ux_1 and Ux_2, i.e. their absolute values, are evaluated with the aid of the microcontroller in accordance with the algorithm illustrated in FIG. 8 in order to monitor flicker states of the high-pressure discharge lamp and the influence of shaking or vibrations on lamp operation.

In order to prove flicker states in accordance with the flicker state illustrated schematically in FIG. 1, the difference Ux_1−Ux_2 is compared with the predetermined reference value or threshold value Dn_F for this difference for each half-cycle of the lamp running voltage. If the difference exceeds this threshold value, this is evaluated as indicating the presence of a flicker state, and the counter FZ_1 is increased by a specific value, for example by 1.

In order to prove the presence of modulation of the lamp running voltage brought about by shaking or vibrations (FIG. 4), the maximum value Ux_2_max and the minimum value Ux_2_min of the second measured values Ux_2 are determined over a duration of a plurality of half-cycles of the lamp running voltage. In accordance with variant a) of this algorithm, the abovementioned maximum value and minimum value are determined independently of the result of the preceding test for the presence of a flicker state. In accordance with the preferred variant b), the abovementioned extreme values Ux_2_max and Ux_2_min are only determined, however, once the presence of a flicker state has already previously been established and the counter FZ_1 has been incremented.

Then, the second measured values Ux_2 of each half-cycle of the lamp running voltage are compared with a predetermined reference value Un_2_La_max in order to monitor the event of a maximum permissible value of the lamp running voltage being exceeded. Each instance of the abovementioned reference value or threshold value Un_2_La_max being exceeded results in incrementation of the counter LüZ_1. For example, the counter LüZ_1 is in this case increased by 1.

Then, the second measured values Ux_2 of each half-cycle of the lamp running voltage are additionally compared with the predetermined reference value Un_2_Flicker2, which is greater than the reference value Un_2_La_max, in order to prove the presence of a flicker state in accordance with FIG. 3. When the reference value or threshold value Un_2_Flicker2 is exceeded, the same counter FZ_1 which was already used for proving the flicker state as shown in FIG. 1 (flicker lamp voltage mode 1) is incremented. Since the flicker state shown in FIG. 1 (flicker lamp voltage mode 2) represents a substantially more severe fault in the lamp operation than the flicker state shown in FIG. 1, the counter FZ_1 is in this case incremented to a greater degree, i.e. for example increased by the value 2, than in the case of the first flicker state. That is to say the flicker states shown in FIGS. 1 and 3 are weighted at a ratio of 1 to 2.

Then, a test is carried out to ascertain whether the duration t_Timer1 defined by Timer1, which duration is in this case 0.5 second and extends over 360 half-cycles of the lamp running voltage, has elapsed. Accordingly, the above-explained procedure is repeated for the next half-cycle or vibration detection is carried out.

For vibration detection purposes, the difference Ux_2_max−Ux_{—}2 min is formed from the extreme values Ux_2_max, Ux_2_min, which were determined during the abovementioned duration t_Timer1 from the measured values Ux_2, and compared with the predetermined reference value or threshold value Dn_V for this difference. If this difference exceeds the predetermined threshold value Dn_V, this is evaluated as influencing of the lamp running voltage by shaking or vibrations, and the counters FZ_1, LüZ_1 and Timer1 are cleared or reset. Likewise, the extreme values Ux_2_max and Ux_2_min are also cleared, and a test is carried out to ascertain whether the duration t_Timer2 determined by Timer2 has already elapsed. If the duration t_Timer2 has not yet elapsed, the system returns to the start of the algorithm and the procedure is repeated for the next half-cycles of the lamp running voltage. That is to say those half-cycles of the lamp running voltage which were influenced by shaking or vibrations are not used for evaluating flicker states or elevated lamp running voltage. The other case will be explained below.

If the abovementioned difference Ux_2_max−Ux_2_min does not exceed the predetermined reference value Dn_V, i.e. if no influencing of the lamp running voltage by shaking or vibrations has been detected, the present value of the counter FZ_1 for the flicker state is compared with the predetermined permissible maximum value FZn_1 for the counter reading of the counter FZ_1. When the permissible maximum value is exceeded, the counter FZ_2 which counts the flicker events over the duration t_Timer2 is incremented. In addition, the present reading of the counter LüZ_1 for elevated lamp running voltage is compared with the predetermined permissible maximum value LüZn_1 for the counter reading of the counter LüZ_1 and, when this permissible maximum value is exceeded, the counter LüZ_2 which counts the events of elevated lamp running voltage over the duration t_Timer2 is incremented. Then, the counters FZ_1, LüZ_1 and Timer1 are cleared or reset. Likewise, the extreme values Ux_2_max and Ux_2_min are also cleared, and a test is carried out to ascertain whether the duration t_Timer2 determined by Timer2 has already elapsed. If the duration t_Timer2 has not yet elapsed, the system returns to the start of the algorithm and the procedure is repeated for the next half-cycles of the lamp running voltage.

Once the duration t_Timer2, which is determined by Timer2 and in this case is 180 seconds, has elapsed, the present value of the counter FZ_2 is compared with a predetermined permissible maximum value FZ_2 for the counter reading of the counter FZ_2. When this maximum value is exceeded, a status bit is set for the presence of a flicker state in order to trigger, for example, a corresponding indicator in a display or in order to bring about shutdown of the control gear or the high-pressure discharge lamp.

In addition, the present value of the counter LüZ_2 is compared with a predetermined permissible maximum value LüZn_2 for the counter reading of the counter LüZ_2. When this maximum value is exceeded, a status bit for the presence of an elevated lamp running voltage is set in order to trigger, for example, a corresponding indicator in a display or in order to bring about shutdown of the control gear or the high-pressure discharge lamp.

If no shutdown of the control gear takes place, Timer2 is then reset, and the counters FZ_2 and LüZ_2 are cleared and the system returns to the start of the algorithm, in order to rerun it for the next half-cycles of the lamp running voltage.

The predetermined reference values Un_2_La_max, Un_2_Flicker2, Dn_F and Dn_V are stored permanently in a memory element of the control gear or the microcontroller and have the same values for each control gear of the same type. In order to fix the abovementioned, predetermined reference values, a reference lamp was operated under defined operating conditions using reference control gear, and the time profile of the lamp running voltage was measured for the operating situations illustrated in FIGS. 1 to 4 and for fault-free lamp operation. Comparison of the lamp running voltage during fault-free lamp operation with the lamp running voltage during in each case one of the situations illustrated in FIGS. 1 to 4 makes it possible to fix the abovementioned, predetermined reference values which, when exceeded, cause the system to leave the fault-free lamp operation. For example, in order to fix the first, predetermined reference or threshold value during fault-free operation of the reference lamp using the reference control gear in the manner described above, measured values Ux_1, Ux_2 were determined and their difference was formed. The first, predetermined reference value or threshold value was fixed by a predeterminable tolerance being added to the difference Ux_1−Ux_2 of the abovementioned measured values Ux_1, Ux_2. In a similar manner, the other predetermined reference or threshold values were fixed.

As has already been explained further above, the predetermined reference value Un_2_Flicker2 is greater than the sum of the predetermined reference values Un_2_La_max and Dn_V in order to prevent a high lamp running voltage from being confused with a flicker state.

The predetermined, permissible maximum values for the counter reading of the counters FZn_1, LüZn_1, FZn_2 and LüZn_2 are either likewise permanently stored in a memory element of the control gear or of the microcontroller and are the same for each control gear of the same type, or are alternatively fixed by the software implemented in the microcontroller. For example, the permissible maximum value FZn_1 is reached if, at 70% of the half-cycles of the lamp running voltage from the period t_Timer1, the difference Ux_1−Ux_2 is greater than Dn_F or, at 35% of the half-cycles of the lamp running voltage from the period t_Timer1, the measured value Ux_2 is greater than Un_2_Flicker2 (ratio 1 to 2 [35%/70%] with a weighting of 1 to 2). The permissible maximum value LüZn_1 for the counter LüZ_1 for the elevated lamp running voltage is achieved if, at 97% of the half-cycles of the lamp running voltage from the period t_Timer1, the measured value Ux_2 is greater than the reference value Un_2_La_max. Similarly, the other permissible maximum values FZn_2 and LüZn_2 for the counters FZ_2 and LüZ_2 can also be fixed.

In accordance with the preferred exemplary embodiments of the method according to the invention, the difference of the measured values Ux_1, Ux_2 and the extreme values Ux_2_max and Ux_2_min is evaluated. This method has the advantage that detection of faults in lamp operation is independent of the level of the lamp running voltage. Alternatively, however, the quotient of the abovementioned measured values or extreme values for comparison with a predetermined reference value could also be evaluated.

FIG. 9 illustrates a block circuit diagram of control gear in accordance with the second exemplary embodiment of the invention. In contrast to the first exemplary embodiment shown in FIG. 6, which has a purely digital evaluation unit, the control gear in accordance with the second exemplary embodiment has a mixed analog/digital evaluation unit. The control gear shown in the block circuit diagram in FIG. 9 likewise comprises a full-bridge inverter with a high-pressure discharge lamp connected into the bridge branch and an ignition apparatus (igniter) for the lamp as well as a DC voltage supply circuit for the full-bridge inverter. In addition, the control gear has a microcontroller (μ-controller) for controlling the full-bridge inverter and its DC voltage supply circuit. The control gear in accordance with the second exemplary embodiment differs from the control gear in accordance with the first exemplary embodiment merely by the analog evaluation unit, which comprises a plurality of operational amplifiers and sample-and-hold elements and is connected upstream of the microcontroller.

The high-pressure discharge lamp is operated by means of the full-bridge inverter at a substantially square-wave AC voltage at a frequency of approximately 360 hertz. The lamp current and the running voltage of the high-pressure discharge lamp for power control of the lamp are measured and evaluated with the aid of the microcontroller. In addition, substantially the above-described algorithm (FIG. 8) is carried out by means of the microcontroller and by means of the evaluation unit, which is illustrated schematically in FIG. 9 and is connected between the terminals of the microcontroller and the center tap between the full-bridge inverter and its DC voltage supply circuit.

The reference symbols Ux_1, Ux_2 in this case do not denote the two measured values from the first or second half of each half-cycle of the lamp running voltage, though, but mean values of the lamp running voltage which are formed by the analog evaluation unit from the measured values during the first period t1 or during the second period t2 for each half-cycle of the lamp running voltage, the first period t1 in each half-cycle of the lamp running voltage extending over part of the first half of this half-cycle or over the entire first half of the half-cycle, and the second period t2 in each half-cycle of the lamp running voltage extending over part of the second half of this half-cycle or over the entire second half of this half-cycle of the lamp running voltage, for example from t1 to T/2. FIG. 10 schematically illustrates the time profile of the running voltage (U_Lamp) of the high-pressure discharge lamp and the splitting of the half-cycles of the running voltage into two halves with the time intervals t1, t2 and the period duration T of the running voltage. The rectangles flecked with gray Ux_1, Ux_2 in the central part of FIG. 10 symbolize that, during the time intervals t1, t2, measured values of the lamp running voltage are determined and, from these, by summating or integrating these measured values over the time intervals t1, t2 for each time interval t1 or t2, in each case one mean value Ux_1 or Ux_2 of the lamp running voltage which is representative of this time interval is formed and used for further evaluation purposes. In this case, too, the absolute values of the mean values Ux_1, Ux_2 are used for evaluation purposes. The lower part of FIG. 10 shows the difference of the mean values Ux_1, Ux_2 on an enlarged scale for the vertical axis and the corresponding predetermined first reference or threshold value Dn_F, which is denoted as the trigger threshold in FIG. 10.

The mean value Ux_1 of each half-cycle of the lamp running voltage is supplied to the first input of the operational amplifier D_F, and the mean value Ux_2 of the same half-cycle of the lamp running voltage is supplied to the second, inverting input of the operational amplifier D_F. The output signal of the operational amplifier D_F (differentiator) is supplied to the first input of a further operational amplifier, whose second input is provided with the predetermined reference value Dn_F for the flicker state shown in FIG. 1. This operational amplifier functions as a threshold value switch. Its output is connected to an input of the microcontroller.

The maximum and minimum values are determined from the mean values Ux_2 of different half-cycles of the lamp running voltage by means of sample-and-hold elements and supplied to in each case one input of the operational amplifier D_V. The differential signal at the output of the operational amplifier D_V is supplied to the first input of a second operational amplifier, which functions as a threshold value switch and whose second input is provided with the predetermined reference value Dn_V for the vibration detection. The output of this second operational amplifier, which functions as a threshold value switch, is connected to an input of the microcontroller.

The mean values Ux_2 from the second period t2 of the half-cycles of the lamp running voltage are in addition in each case supplied to the first input of an operational amplifier, which functions as a threshold value switch and whose second input is provided with the predetermined reference value U_La_max for the maximum permissible lamp running voltage or with the predetermined reference value Un_2_Flicker2 for the identification of the flicker state shown in FIG. 3. The output of the two abovementioned operational amplifiers in the form of threshold value switches is in each case connected to an input of the microcontroller.

In the microcontroller, a corresponding status bit for the occurrence of a flicker state or an elevated lamp running voltage is set as a function of the output signal of the abovementioned operational amplifier which functions as a threshold value switch, and possibly shutdown of the control gear is triggered. If, during the monitored period, the occurrence of shaking or vibrations has been detected, the evaluation of the half-cycles of the lamp running voltage with respect to the flicker states illustrated in FIGS. 1 and 3 and the elevated lamp running voltage illustrated in FIG. 2 is interrupted for this period.

The predetermined reference values Dn_F, Dn_V, Un_2_Flicker2 and Un_2_La_max or U_La_max have different values for both exemplary embodiments.

The invention is not restricted to the exemplary embodiments explained in more detail above. For example, not every half-cycle of the lamp running voltage needs to be used and evaluated for monitoring the lamp running voltage. It is sufficient if, for example, only the half-cycles of one polarity are evaluated for the monitoring. In addition, instead of the lamp running voltage, another lamp operation parameter, which is influenced by flicker states and shaking or vibrations of the lamp, for example the lamp current, can also be used for monitoring the high-pressure discharge lamp.

1. A method for operating a high-pressure discharge lamp with an electrical voltage with a periodically alternating polarity, the occurrence of a flickering or flicker state in the high-pressure discharge lamp being monitored during lamp operation, characterized in that, during lamp operation, the occurrence of shaking or vibrations of the high-pressure discharge lamp is monitored.

2. The method as claimed in claim 1, characterized in that the monitoring for shaking or vibrations is only carried out during the occurrence of a flickering or flicker state.

3. The method as claimed in claim 1, characterized in that an electrical lamp operation parameter or an electrical variable correlated therewith is monitored for detecting the flickering or flicker state and detecting shaking or vibrations of the high-pressure discharge lamp.

4. The method as claimed in claim 3, characterized in that, in addition, the event of a maximum permissible value (Un_2_La_max; U_La_max) of the lamp operation parameter being exceeded is monitored.

5. The method as claimed in claim 3, characterized in that the electrical lamp operation parameter is the running voltage of the high-pressure discharge lamp.

6. The method as claimed in claim 1, characterized in that, in order to monitor the lamp operation, at least one measured value of the lamp operation parameter is determined during a first time period (t1), and at least one measured value of the lamp operation parameter is determined during a second time period (t2), the first time period (t1) being arranged within the first half, and the second time period (t2) being arranged within the second half, of the time interval of a half-cycle of the periodic voltage.

7. The method as claimed in claim 6, characterized in that, in order to detect the flickering or flicker state, a first comparison variable is formed from the at least one measured value during the first time period (t1) and the at least one measured value during the second time period (t2), which first comparison variable is compared with a predetermined first reference value (Dn_F) for the first comparison variable.

8. The method as claimed in claim 6, characterized in that, in order to detect the flicker state, a second comparison variable is formed from the at least one measured value during the second time period (t2), which second comparison variable is compared with a predetermined second reference value (Un_2_Flicker2) for the second comparison variable.

9. The method as claimed in claim 8, characterized in that, in order to detect shaking or vibrations, the maximum value (Ux_2_max) and the minimum value (Ux_2_min) are determined from the measured values which were determined during the second time periods (t2) of a plurality of half-cycles, and a third comparison variable is formed therefrom which is compared with a predetermined third reference value (Dn_V) for the third comparison variable.

10. The method as claimed in claim 9, characterized in that, in order to detect the event of the maximum permissible value for the lamp operation parameter being exceeded, the measured values from the second time periods (t2) of the half-cycles of the periodic voltage are compared with a predetermined fourth reference value (Un_2_La_max; U_La_max).

11. The method as claimed in claim 10, characterized in that the second reference value (Un_2_Flicker2) is greater than the sum of the third reference value (Dn_V) and the fourth reference value (Un_2_La_max; U_La_max).

12. The method as claimed in claim 6, characterized in that, during each first time period (t1) and second time period (t2), in each case only one measured value is determined.

13. The method as claimed in claim 12, characterized in that the measured value from the first time period (t1) is determined immediately after the change in polarity and the measured value from the second time period (t2) is determined immediately before the change in polarity in the corresponding half-cycle of the periodic voltage.

14. Control gear for a high-pressure discharge lamp having a voltage supply circuit for applying an electrical voltage with alternating polarity to the high-pressure discharge lamp, the control gear having a device for carrying out the method as claimed in claim 1.

15. The control gear as claimed in claim 14, characterized in that the device has a measuring apparatus for iteratively measuring a lamp operation parameter, which is influenced by a flicker state and shaking or vibrations of the high-pressure discharge lamp, and an evaluation unit for evaluating the measured values determined by the measuring apparatus.

16. The control gear as claimed in claim 15, characterized in that the evaluation unit comprises a programmable microcontroller and/or a logic circuit.

17. An illumination device having a high-pressure discharge lamp and control gear for the high-pressure discharge lamp as claimed in claim 14.

18. The illumination device as claimed in claim 17, which is in the form of a vehicle headlamp.

19. The method as claimed in claim 6, characterized in that, in order to detect shaking or vibrations, the maximum value (Ux_2_max) and the minimum value (Ux_2_min) are determined from the measured values which were determined during the second time periods (t2) of a plurality of half-cycles, and a third comparison variable is formed therefrom which is compared with a predetermined third reference value (Dn_V) for the third comparison variable.

20. The method as claimed in claim 6, characterized in that, in order to detect the event of the maximum permissible value for the lamp operation parameter being exceeded, the measured values from the second time periods (t2) of the half-cycles of the periodic voltage are compared with a predetermined fourth reference value (Un_2_La_max; U_La_max).
